(19) United States
(12) Patent Application Publication
(10) Pub. No.: US 2021/0181884 A1
(43) Pub. Date: Jun. 17, 2021

(54) PRESSURE SENSING TOUCH MODULE AND MANUFACTURE METHOD THEREOF

(71) Applicant: WUHAN CHINA STAR OPTOELECTRONICS SEMICONDUCTOR DISPLAY TECHNOLOGY CO., LTD., Wuhan (CN)

(72) Inventor: Lun SHANG, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/334,374

(22) PCT Filed: Nov. 1, 2018
(86) PCT No.: PCT/CN2018/113255

§ 371 Date: Mar. 19, 2019

(30) Foreign Application Priority Data
Jul. 19, 2018 (CN) 201810797496.8

(51) Int. Cl. G06F 3/041

(52) U.S. Cl. CPC G06F 3/0414; G06F 2203/04103; G06F 3/0412

(57) ABSTRACT

A pressure sensing touch module and a manufacture method thereof are provided. The pressure sensing touch module includes a buffer layer, a substrate, a touch sensing layer and an insulating layer, wherein the touch sensing layer disposed on the substrate, the touch sensing layer configured to sense a position and a strength of a touch pressure applied to the touch sensing layer. Replacing the physical home button on the touch display screen by providing the pressure sensing touch module, which used for sensing the position and the strength of the touch pressure applied to the touch sensing layer, increases the screen ratio of the display area on the touch display screen.

### FIELD OF INVENTION

The present invention relates to field of touch technologies, and more particularly to a pressure sensing touch module and a manufacture method thereof.

### BACKGROUND OF INVENTION

At present, with rapid development of display technology, touch displays have spread all over people's lives. With rapid development of portable electronic terminal devices, especially mobile phones and tablet technologies, pressure sensing touch technology has received extensive attention in the field of display technology. With the pressure sensing touch technology, the portable electronic terminal devices not only can recognize a position where a user touches, but also sense strength of the touch pressure.

At present, the portable electronic terminal device has a touch function, but a physical home button (for returning to the desktop) setting on the terminal device occupies a certain area on the touch display screen, thereby reducing display area of the touch display screen and affecting display performance.

In summary, the physical home button on the existing portable electronic terminal device affects the screen ratio of the display area, thereby affecting the display performance.

### SUMMARY OF INVENTION

The present invention provides a pressure sensing touch module to solve the problem that the physical home button on the existing touch display screen affects the screen ratio of the display area.

In order to solve the above-mentioned problems, the technical solutions provided by the present invention are as follows:

The present invention provides a pressure sensing touch module, including: a buffer layer; a substrate disposed on the buffer layer, a touch sensing layer disposed on the substrate, the touch sensing layer configured to sense a position and a strength of a touch pressure applied to the touch sensing layer; an insulating layer disposed on the touch sensing layer; a first adhesive layer disposed between the buffer layer and the substrate; and a second adhesive layer disposed on a surface of the insulating layer, wherein the touch sensing layer is made of a silver nanofiber material.

In one embodiment of the present invention, an overall thickness of the pressure sensing touch module is 0.13-0.17 mm.

In one embodiment of the present invention, the touch sensing layer comprises a plurality of patterned lines, a line width of each of the patterned lines is 7-9 μm, and a vertical distance between the patterned lines is 7-9 μm.

In one embodiment of the present invention, a thickness of the touch sensing layer is 7-13 μm.

In one embodiment of the present invention, the substrate is made of a polyimide material.

The present invention further provides a pressure sensing touch module, including: a buffer layer; a substrate disposed on the buffer layer; a touch sensing layer disposed on the substrate, the touch sensing layer configured to sense a position and a strength of a touch pressure applied to the touch sensing layer; and an insulating layer disposed on the touch sensing layer.

In one embodiment of the present invention, the pressure sensing touch module further comprises a first adhesive layer and a second adhesive layer, the first adhesive layer disposed between the buffer layer and the substrate, the second adhesive layer disposed on a surface of the insulating layer.

In one embodiment of the present invention, an overall thickness of the pressure sensing touch module is 0.13-0.17 mm.

In one embodiment of the present invention, the touch sensing layer comprises a plurality of patterned lines, a line width of each of the patterned lines is 7-9 μm, and a vertical distance between the patterned lines is 7-9 μm.

In one embodiment of the present invention, the touch sensing layer is made of a silver nanofiber material.

In one embodiment of the present invention, a thickness of the touch sensing layer is 7-13 μm.

In one embodiment of the present invention, the buffer layer is made of a foam material.

In one embodiment of the present invention, the first adhesive layer and the second adhesive layer are both made of an optical adhesive.

In one embodiment of the present invention, the substrate is made of a polyimide material.

The present invention further provides a manufacture method of a pressure sensing touch module including:

step S10, forming a first adhesive layer on a buffer layer;

step S20, disposing a substrate on a surface of a first adhesive layer;

step S30, forming a touch sensing layer on a surface of the substrate;

step S40, forming an insulating layer on a surface of the touch sensing layer, and the insulating layer covering the touch sensing layer; and

step S50, forming a second adhesive layer on a surface of the insulating layer.

In one embodiment of the present invention, the step S30 includes steps of:

step S301, depositing a nano silver film on the surface of the substrate;

step S302, coating a photoresist on a surface of the nano silver film, exposing and developing the photoresist to from a photoresist retention region and a photoresist removal region;

step S303, etching the nano silver film to form a plurality of patterned lines;

step S304, striping the photoresist to form the touch sensing layer.

In one embodiment of the present invention, a line width of each patterned line is 7-9 μm, and a vertical distance between the patterned lines is 7-9 μm.

In one embodiment of the present invention, a thickness of the touch sensing layer is 7-13 μm.

In one embodiment of the present invention, the first adhesive layer and the second adhesive layer are both made of an optical adhesive.

In one embodiment of the present invention, the buffer layer is made of a foam material.

The beneficial effect of the present invention: the present invention provides a pressure sensing touch module for sensing the position and a strength of a touch pressure applied to the touch sensing layer, in order to replace the physical home button on the touch display screen to improve the aspect ratio of the display area on the touch display screen.

### DESCRIPTION OF DRAWINGS

In order to more clearly illustrate the technical solutions in the embodiments or the prior art, the following drawings, which are intended to be used in the description of the embodiments or the prior art, will be briefly described. It will be apparent that the drawings and the following description are only some embodiments of the present invention. Those of ordinary skill in the art may, without creative efforts, derive other drawings from these drawings.

FIG. 1 is schematic structural view of a pressure sensing touch module according to a preferred embodiment 1 of the present invention.

FIG. 2 is a flowchart showing the steps of manufacture method of a pressure sensing touch module of the present invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, “left”, “right”, “inside”, “outside”, “side”, etc., is used with reference to the orientation of the figure(s) being described. As such, the directional terminology is used for purposes of illustration and is in no way limiting. Throughout this specification and in the drawings like parts will be referred to by the same reference numerals.

The present invention is directed to the existing touch display screen. Due to the physical home button set on the touch display screen, a part of the area of the display screen cannot be used as a display area, which affects the screen ratio of the display area, thereby affecting the technical problem of display. The embodiments of the present invention can solve the drawback.

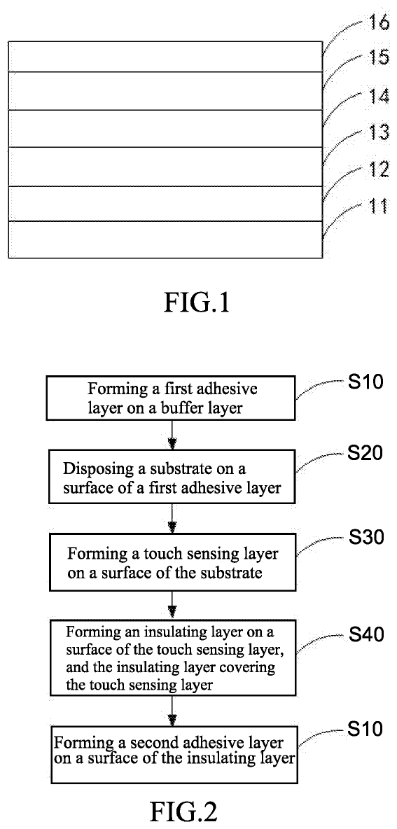

As shown in FIG. 1, the present invention provides a pressure sensing module, including: a buffer layer 11, a first adhesive layer 12, a substrate 13, a touch sensing layer 14, an insulating layer 15, and a second adhesive layer 16. The first adhesive layer 12 is disposed on the buffer layer 11. The substrate 13 disposed on the buffer layer 12. The touch sensing layer 14 disposed on a surface of the substrate 13. The insulating layer 15 is disposed on the touch sensing layer 14. The second adhesive layer 16 is disposed on the insulating layer 15.

An overall thickness of the pressure sensing touch module is 0.13-0.17 mm. Each layer of the pressure sensing touch module is made of an organic polymer material. The pressure sensing touch module is attached to the backside of the OLED display layer, and the buffer layer 11 contacts with the middle frame of the whole display device as a support.

The buffer layer 11 mainly serves as a buffering function to prevent the display screen from affecting the touch sensing layer 14 when the display screen deformed in operation. The buffer layer 11 is made of a foam material having a relatively high density, and the foam material has the characteristics of good elasticity, light in weight and thin in volume.

The first adhesive layer and the second adhesive layer function as a connection. The first adhesive layer is used to connect the substrate 13 and the buffer layer 11. The second adhesive layer is used to connect the upper surface of the pressure sensing touch module with other components of the touch display screen. The first adhesive layer and the second adhesive layer are both made of an optical clear adhesive (OCA). The OCA has the characteristics of high light transmittance and high adhesion, and the OCA does not cause problems of yellowing, peeling, and deterioration for a long period of use.

The substrate 13 is made of a polyimide material, the polyimide material has bending resistance and can deal with deformation when the touch screen is in operation.

A thickness of the touch sensing layer 14 is 10 μm. The touch sensing layer 14 is made of a silver nanofiber material, which has high transparency and high reliability. Forming the touch sensing layer 14 on the surface of the substrate 13 by a mask process. The benefit of using the mask process is that the patterned lines of the silver nanofiber on the touch sensing layer 14 can be brought to the required accuracy. The line width of each of the patterned lines of the silver nanofiber is 8 μm, and a vertical distance between the patterned lines of the silver nanofiber is 8 μm.

As shown in FIG. 2, the present invention further provides a manufacture method of a pressure sensing touch module, including the following steps:

Step S10, forming a first adhesive layer 12 on a buffer layer 11.

Wherein the buffer layer 11 mainly serves as a buffering function to prevent the display screen from affecting the touch sensing layer 14 when the display screen deformed in operation. The buffer layer 11 is made of a foam material having a relatively high density, and the foam material has the characteristics of good elasticity, light in weight, and thin in volume.

Step S20, disposing a substrate 13 on a surface of a first adhesive layer.

Wherein the substrate 13 is made of a polyimide material, the polyimide material has bending resistance and can deal with deformation when the touch screen is in operation.

Step S30, forming a touch sensing layer 14 on a surface of the substrate 13.

First, after the steps of cleaning the silver nanofiber with water, ultrasonic cleaning, and chemical cleaning, depositing nano silver film on the surface of the substrate by magnetron sputtering. Then, coating a photoresist on the surface of the nano silver film, exposing and developing the photoresist to retain the photoresist which is illuminated by the light and to remove the photoresist which is non-illuminated by the light. And etching the nano silver film to form the touch sensing layer 14 and to obtain a plurality of patterned lines of the silver nanofiber. Finally, stripping the photoresist.

Wherein, a thickness of the touch sensing layer 14 is 10 μm. The line width of each of the patterned lines of the silver nanofiber is 8 μm, and a vertical distance between the patterned lines of the silver nanofiber is 8 μm.

Step S40, forming an insulating layer 15 on a surface of the touch sensing layer 14, and the insulating layer 15 covering the touch sensing layer 14.

Wherein, the insulating layer 15 is made of an organic insulating material, the insulating layer 15 is used to protect the touch sensing layer 14.

Step S50, forming a second adhesive layer 16 on a surface of the insulating layer 15.

An overall thickness of the pressure sensing touch module is 0.13-0.17 mm. The pressure sensing touch module is attached to the backside of the OLED, and the buffer layer 11 contacts with the middle frame of the whole display device. The pressure sensing touch module can be fabricated using the same manufacturing process according to different display screen sizes.

The beneficial effect: the present invention provides a pressure sensing touch module for sensing the position and a strength of a touch pressure applied to the touch sensing layer, in order to replace the physical home button on the touch display screen to improve the aspect ratio of the display area on the touch display screen.

In view of the above, although the present invention has been disclosed by way of preferred embodiments, the above preferred embodiments are not intended to limit the present invention, and one of ordinary skill in the art, without departing from the spirit and scope of the invention, the scope of protection of the present invention is defined by the scope of the claims.

What is claimed is:

1. A pressure sensing touch module, comprising:
a buffer layer;
a substrate disposed on the buffer layer;
a touch sensing layer disposed on the substrate, the touch sensing layer configured to sense a position and a strength of a touch pressure applied to the touch sensing layer;
an insulating layer disposed on the touch sensing layer;
a first adhesive layer disposed between the buffer layer and the substrate; and
a second adhesive layer disposed on a surface of the insulating layer, wherein the touch sensing layer is made of a silver nanofiber material.

2. The pressure sensing touch module according to claim 1, wherein an overall thickness of the pressure sensing touch module is 0.13-0.17 mm.

3. The pressure sensing touch module according to claim 1, wherein the touch sensing layer comprises a plurality of patterned lines, a line width of each of the patterned lines is 7-9 μm, and a vertical distance between the patterned lines is 7-9 μm.

4. The pressure sensing touch module according to claim 1, wherein a thickness of the touch sensing layer is 7-13 μm.

5. The pressure sensing touch module according to claim 1, wherein the substrate is made of a polyimide material.

6. A pressure sensing touch module, comprising:
a buffer layer;
a substrate disposed on the buffer layer;
a touch sensing layer disposed on the substrate, the touch sensing layer configured to sense a position and a strength of a touch pressure applied to the touch sensing layer; and
an insulating layer disposed on the touch sensing layer.

7. The pressure sensing touch module according to claim 6, wherein the pressure sensing touch module further comprises a first adhesive layer and a second adhesive layer, the first adhesive layer disposed between the buffer layer and the substrate, the second adhesive layer disposed on a surface of the insulating layer.

8. The pressure sensing touch module claim according to claim 7, wherein an overall thickness of the pressure sensing touch module is 0.13-0.17 mm.

9. The pressure sensing touch module according to claim 6, wherein the touch sensing layer comprises a plurality of patterned lines, a line width of each of the patterned lines is 7-9 μm, and a vertical distance between the patterned lines is 7-9 μm.

10. The pressure sensing touch module according to claim 6, wherein the touch sensing layer is made of a silver nanofiber material.

11. The pressure sensing touching module according to claim 10, wherein a thickness of the touch sensing layer is 7-13 μm.

12. The pressure sensing touch module according to claim 6, wherein the buffer layer is made of a foam material.

13. The pressure sensing touch module according to claim 6, wherein the first adhesive layer and the second adhesive layer are both made of an optical adhesive.

14. The pressure sensing touch module according to claim 6, wherein the substrate is made of a polyimide material.

15. A manufacture method of a pressure sensing touch module, comprising:
step S10, forming a first adhesive layer on a buffer layer;
step S20, disposing a substrate on a surface of a first adhesive layer;
step S30, forming a touch sensing layer on a surface of the substrate;
step S40, forming an insulating layer on a surface of the touch sensing layer, and the insulating layer covering the touch sensing layer; and
step S50, forming a second adhesive layer on a surface of the insulating layer.

16. The manufacture method of the pressure sensing touch module according to claim 15, wherein the step S30 comprises steps of:
step S301, depositing a nano silver film on the surface of the substrate;
step S302, coating a photoresist on a surface of the nano silver film, exposing and developing the photoresist to from a photoresist retention region and a photoresist removal region;
step S303, etching the nano silver film to form a plurality of patterned lines;
step S304, striping the photoresist to form the touch sensing layer.

17. The manufacture method of the pressure sensing touch module according to claim 16, wherein a line width of each patterned line is 7-9 μm, and a vertical distance between the patterned lines is 7-9 μm.

18. The manufacture method of the pressure sensing touch module according to claim 15, wherein a thickness of the touch sensing layer is 7-13 μm.

19. The manufacture method of the pressure sensing touch module according to claim 15, wherein the first adhesive layer and the second adhesive layer are both made of an optical adhesive.

20. The manufacture method of the pressure sensing touch module according to claim 15, wherein the buffer layer is made of a foam material.
